(19) United States
(12) Patent Application Publication
(10) Pub. No.: US 2007/0151655 A1
(43) Pub. Date: Jul. 5, 2007

(54) Fabric with high stretch and retained extension

(76) Inventors: Michael A. Keller, Simpsonville, SC (US); Robert S. Brown, Spartanburg, SC (US); Andre M. Goineau, Spartanburg, SC (US); Gary K. Greene, Spartanburg, SC (US); Ronald B. Holland, Greenwood, SC (US); William M. Pascoe, Inman, SC (US)

Correspondence Address: Legal Department (M-495), P.O. Box 1926, Spartanburg, SC, 29304, US

(21) Appl. No.: 11/325,585

(22) Filed: Jan. 4, 2006

(51) Int. Cl. B32B 29/02

(52) U.S. Cl. 156/176

(57) ABSTRACT

A method of forming a moldable fabric face composite. The fabric is formed in a knit or woven structure using underdrawn POY yarns and laminated to a low permeability plastically deformable backing for introduction to a mold. The underdrawn POY yams impart a stretch characteristics such that the fabric undergoes plastic deformation elongation in all directions upon application of force followed by low recovery after force removal.

### TECHNICAL FIELD

The present invention relates generally to three-dimensional moldable multi-layer composites incorporating a surface fabric adapted for vacuum or plug assist molding practices. More particularly, the invention relates to moldable multi-layer composites incorporating knit or woven fabric structures forming a surface overlying a backing structure wherein the fabric structure is characterized by a plastic phase strain (i.e. stretching) to assume three-dimensional shapes corresponding to a mold cavity well at relatively low force levels and with retained or residual strain and low levels of recovery following elimination of the molding force.

### BACKGROUND OF THE INVENTION

Knit and woven fabrics are well known. Knit fabrics are formed by the interlocking of loops of yam so as to form a coordinated structure. By way of example only, such fabrics may be formed by techniques such Raschel and tricot knitting and other techniques as will be well known to those of skill in the art. Woven fabrics are typically formed by arranging groups of yams in transverse orientation to one another such that yams running in a first direction pass over and under yams running in a second direction in a defined manner so as to form a coordinated structure.

The molding of fabrics is generally known. One technique for fabric molding is injection or applied pressure molding in which the fabric is pressed into place across a mold surface by use of a ram or other pressure applying tool. Another technique is vacuum molding in which the fabric is pulled into a contoured mold by an underlying vacuum force either with or without the assistance of a ram. The use of vacuum molding may be desirable in many instances to provide efficiency and precision. However, the relatively low force levels within a vacuum molding process may make it difficult to force the fabric into a desired mold-conforming geometry. By way of example only, and not limitation, one exemplary vacuum molding process is described in U.S. Pat. No. 3,962,392 to Conner Jr. the teachings of which are hereby incorporated by reference. Ram assist and vacuum molding may also be used in combination if desired.

In the past it has been difficult to mold woven fabrics due to their rigidity. Molding of knit fabrics has been somewhat less problematic due to the inherent stretch potential of knit structures. However, even in knit structures, molding has generally relied on the incorporation of a percentage of elastomeric yarns to facilitate multi-directional stretch. Such fabrics are described, for example, in US patent application 2004/0000173 to Keller (incorporated herein by reference). While fabrics with elastomeric yarns provide excellent stretch during molding, it is believed that they may also tend to give rise to residual stress in the final molded fabric. If the fabric is to be used as part of a laminate, it is contemplated that such retained stress may result in undesirable performance during long term use as the fabric seeks to relieve the retained stress. Moreover, such elastomeric yarns may be costly.

It has also been proposed to use facing composites incorporating an aesthetic face layer over a foam layer with a film backing to bond to injection molded articles as disclosed in U.S. Pat. No. 5,456,976 to LaMarca, II (incorporated herein by reference). In the past, the use of such multi-layer composites to cover three-dimensional configurations incorporating deep concave regions such as well portions of door panels and the like has relied on the use of a polymeric aesthetic face layer such as polyvinyl chloride (PVC), thermoplastic olefin (TPO) or the like adhesively joined in overlying relation to a backing formed of a foam layer over a film of polypropylene or the like. In such structures the thermomolded characteristics of the surface are sufficiently matched to the underlying composite layers to permit the deep draw levels associated with covering the depressed regions without giving rise to surface flaws or irregularities.

### SUMMARY OF THE INVENTION

The present invention provides advantages and/or alternatives over the prior art by providing a moldable multi-layer composite structure incorporating a surface fabric of either knit or woven construction particularly adapted to three dimensional molding with subsequent shape retention. The fabric constructions utilize construction materials adapted to provide substantial stretch (i.e. strain) at low stress levels thereby facilitating molding within a ram assisted vacuum cavity or other low force molding operation. Moreover, the strain within the fabrics is substantially plastic in character such that upon removal of the molding force, the imparted stretch is maintained as retained strain without substantial levels of retained residual stress. Such characteristics permit the utilization of fabric as a surface layer in substitution for prior polymeric surface layers. The use of elastomeric yams is not required.

According to one aspect, a process is provided for forming a multi-layer composite adapted for ram assisted vacuum molding and incorporating a surface fabric adhesively joined to a multilayer backing. The fabric is formed substantially from underdrawn, partially oriented synthetic yam (POY) characterized by plastic elongation to break the yam in the fabric construction state of at least 40%. More preferably, the fabric is formed substantially from underdrawn, polyester POY characterized by plastic elongation to break the yam in the fabric construction state of about 60% to about 140%. Most preferably, the fabric is formed substantially from underdrawn, polyester POY characterized by plastic elongation to break the yam in the fabric construction state of about 80% to about 140%

According to one potentially preferred feature, the yam forming the surface fabric is selected such that the surface fabric formed from such yam is characterized by a stress strain curve when subjected to a modified ball burst extension test wherein the modulus measured at the peak load is substantially less than the modulus measured at 50% of the peak load such that the modulus measured at 50% of the peak load is at least 20% greater than the modulus measured at the peak load for woven fabrics and at least 30% to 50% greater for knits.

It has been found that by predetermination and processing to yield these characteristics, the fabric structure undergoes substantial non-recoverable stretch during the fabric molding process which is then retained upon completion of the molding procedure. Moreover, in a potentially preferred practice, the non-recoverable stretch may be carried out at low force levels consistent with ram assisted vacuum molding or other low force molding procedures as may be desired. Other aspects and features of the invention will become apparent to those of skill in the art upon reading the following detailed description and/or through practice of the invention.

### BRIEF DESCRIPTION OF THE DRAWINGS

The present invention will be described by way of example only, with reference to the accompanying drawings which constitute a portion of the specification herein and wherein:

FIG. 1 is a schematic cross-sectional view of an exemplary moldable composite incorporating a surface fabric;

FIG. 2 is a flow chart setting forth exemplary steps for formation of a fabric composite with low elastic recovery character suitable for use in thermal molding;

FIG. 3 illustrates an exemplary processing line for a yarn for use in a surface fabric for a moldable composite;

FIG. 4 illustrates another exemplary processing line for a yam for use in a surface fabric for a moldable composite;

FIG. 5 is an exemplary multi-filament yam; and

FIGS. 6-15 are stress-strain curves for various tested constructions.

While the present invention has been generally described above and will hereinafter be described in greater detail in relation to certain illustrated and potentially preferred embodiments, procedures and practices it is to be understood that in no event is the invention to be limited to such illustrated and described embodiments, procedures and practices. Rather, it is intended that the invention shall extend to all embodiments, practices and procedures as may be embodied within the broad principles of the invention.

### DESCRIPTION OF THE PREFERRED EMBODIMENTS

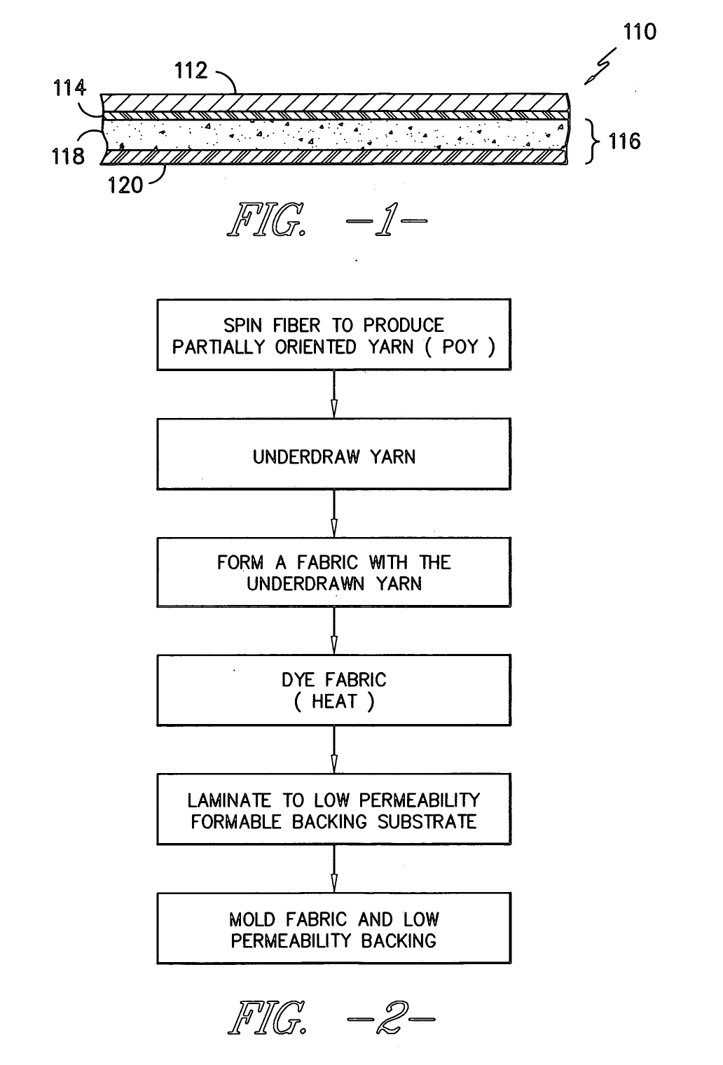

Reference will now be made to the various figures wherein, to the extent possible, like elements are designated by like reference numerals throughout the various views. In FIG. 1 there is illustrated a multi-layer moldable composite 110 incorporating a surface fabric 112 of knit or woven construction joined to a pliable backing 116 by an adhesive layer 114 such as an ethylene methyl acrylate (EMA) or the like as will be known to those of skill in the art. By way of example only, one such EMA formulation which may be utilized is sold by ExxonMobile Chemical under the trade designation OPTIMA EMA TC 120.

In the illustrated and potentially preferred construction, the backing 116 includes a foam layer 118 overlying a thermoplastic polymer backing layer 120. As shown, the backing layer 120 is disposed below the foam layer 118 so as to face away from the fabric 112. The backing layer 120 and the foam layer 118 are preferably chemically similar to promote secure adhesion.

Without limitation, according to one potentially preferred arrangement, the foam is a closed cell, partially cross linked low pressure molding grade polypropylene having a density of about 4 pounds per cubic foot available from Toray Plastics (America), Inc.—PEF Division having a place of business in Troy, Mich. with a manufacturing location in Front Royal, Va. It is contemplated that such foam is preferably present at a thickness of about 1 mm to about 8 mm, more preferably about 2 mm to about 6 mm and most preferably, about 2 mm to about 4 mm. In this regard it is contemplated that thicker foam layers of about 3 mm or greater may facilitate more extreme thermoplastic molding conditions.

The backing layer 120 is preferably an extrusion coating of substantially non-cellular thermoplastic material compatible with the foam layer. By way of example only, in the event that the polypropylene foam as described above is used in the foam layer 118, the backing layer 120 may be formed of an extrudable polypropylene resin. One exemplary resin is a homopolymer resin available from ExxonMobile Chemical under the trade designation PP3155. It is contemplated that the backing layer 120 is preferably present at a thickness of about 0.05 mm (2 mils) to about 1.5 mm (59 mils) and more preferably about 0.38 mm (15 mils) to about 1 mm (39 mils). The composition and structure of the backing layer 120 is preferably such that it may be securely adhered by thermoforming to the surface of an automotive interior panel such as a door panel, instrument panel bolster arm or the like as the panel is being injection molded while minimizing gate registration at the entry points of the molten polymer. Of course, it is contemplated that a number of thermoplastic polymeric materials other than polypropylene as will be known to those of skill in the art may be utilized if desired. It is likewise contemplated that attachment techniques other than extrusion coating may be used if desired. By way of example only, in the event that the backing layer 120 is in film form, attachment techniques may include adhesive film lamination, cold calendering and the like.

As noted previously, the multi-layer moldable composite 110 is intended to be thermally moldable in covering, form fitting relation across a three-dimensional structural body that includes regions of substantial relative concavity. Thus, the moldable composite 110 preferably exhibits suitable initial molding deformation as well as a substantial retention of the molded shape without delamination after molding is complete. It has been found that the character of the surface fabric 112 is a significant factor in achieving desired performance. In particular, it has been found that a controlled manipulation of the fibers in yams forming the surface fabric 112 permits the fabrics to stretch to levels consistent with the molding process in conjunction with the backing 116 without substantial subsequent recovery that may give rise to undesirable delamination and without the need to use significant levels of elastomeric yam components.

According to the potentially preferred practice, the surface fabric is formed substantially from underdrawn, partially oriented synthetic yam (POY) characterized by substantial retained plastic strain capacity such that the yam is characterized plastic elongation in the fabric construction state of at least 40%, and more preferably about 60% to about 140%. In this regard, it is to be understood that the term “fabric construction state” refers to the state of the yarns when they are formed into the fabric following any drawing and/or heat setting operation.

It has been found that a class of potentially desirable fabrics incorporating underdrawn partially oriented yams is characterized by stress-strain performance when subjected to a modified ball burst test such that the modulus measured at the peak load corresponding to initiation of sample failure is substantially less than the modulus measured at 50% of the peak load. Such a modified ball burst test may be carried out in conformance with the procedures outlined in ASTM standard D 6797-02 entitled “Bursting Strength of Fabrics Constant-Rate-of-Extension (CRE) Ball Burst Test” (incorporated herein by reference) modified to use a 4.25 inch diameter ball with a sample held in a 6 inch diameter ring clamp. In particular, the underdrawn partially oriented yams are preferably characterized by stress-strain performance when subjected to such a test such that the modulus of the fabric measured at 50% of the peak load is at least 20% greater than the modulus measured at the peak load. More preferably, for a fabric incorporating polyester yams, the modulus of the fabric measured at 50% of the peak load is at about 30% to 50% greater than the modulus measured at the peak load. As will be appreciated, such characteristics reflect a decreasing slope to the stress/strain curve as the test proceeds towards failure.

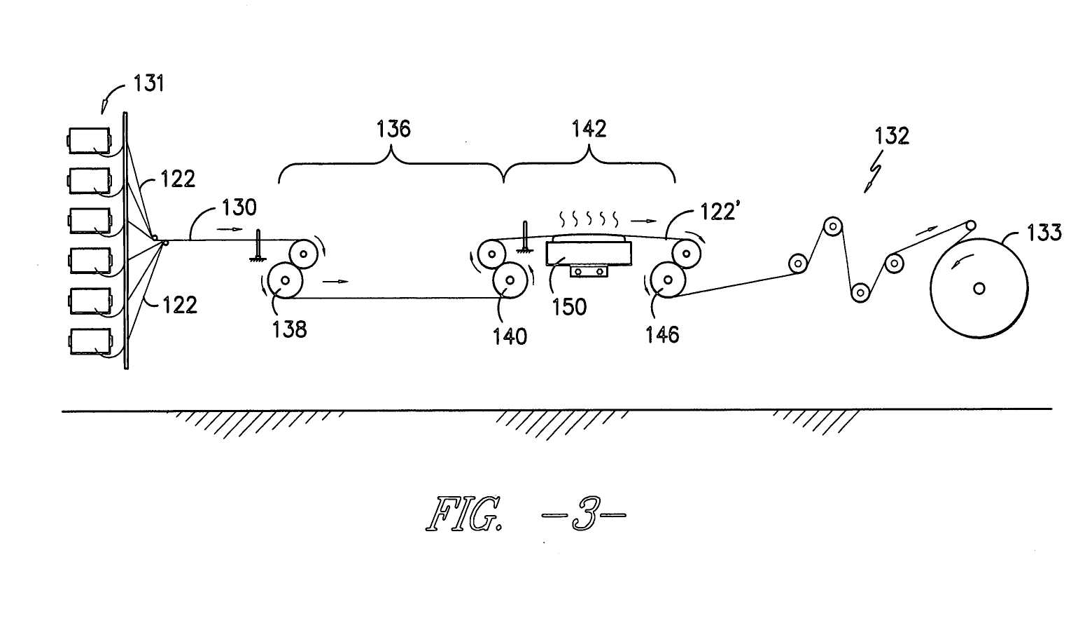

In FIG. 2 there is illustrated a block diagram setting forth steps for forming and molding an exemplary multi-layer composite construction. In accordance with the exemplary practice set forth in FIG. 2, polymeric fibers such as polyester, polypropylene, nylon or the like are spun from a spinneret and formed into a yam that is then subjected to a draw to yield a yarn of partially oriented construction. Such yam is commonly referred to as Partially Oriented Yam or POY. The yam is preferably of multifilament construction formed from a plurality of filaments of any filament cross-section design. However, it is contemplated that monofilament constructions may also be used in some applications.

As will be appreciated by those of skill in the art, polymeric yam fibers are made up of crystalline and amorphous regions. In the fiber, various percentages of the crystalline and amorphous regions may be either substantially oriented or substantially isotropic depending on yam treatment practices. That is, a percentage of the crystalline regions may be either substantially oriented or substantially isotropic. Likewise, a percentage of the amorphous regions may be either substantially oriented or substantially isotropic. The levels of cystallinity and orientation are generally a function of heat history and draw ratio applied to the yarn.

According to one contemplated practice, the desired characteristics in the yarn are achieved through a combination of heat setting and under drawing of the yarn in a manner to yield predefined levels of retained plastic strain capacity yielding substantial non-recoverable elongation in the yarn when linear stress is applied. According to the exemplary process as set forth in FIG. 2, the yarn is under drawn using little if any tensioning force as it is heated thereby resulting in substantial retained elongation potential. It has been found that applying such drawing conditions to the yarn provides a sufficient degree of heat stabilization to permit subsequent formation into a knit or woven construction while nonetheless permitting retention of substantial non-recoverable elongation potential within the yams. The yam is thereafter knitted or woven into a fabric that optionally may be subjected to a dye treatment such as jet dyeing or the like wherein heat is applied at temperatures of about 100 degrees Celsius or more. The fabric may then be laminated to a backing structure as previously described to form a moldable composite. The non-recoverable elongation potential within the yarns is translated to the resulting fabric in the composite state such that the fabric provides little if any recovery force after molding has taken place.

By way of example only, and not limitation, one exemplary yam treatment practice is illustrated in FIG. 3. According to such exemplary practice, a yarn sheet 130 formed from a plurality of yarns 122 is passed from a creel 131 through a drawing apparatus 132 to a take-up 133. The yarns 122 are partially oriented yarns of multi-filament construction wherein the filaments 126 (FIG.5) have been interlaced at discrete zones along the length of the yarn. In practice it is contemplated that the yarns are formed from a heat shrinkable material, such as a thermoplastic. By way of example only and not limitation, exemplary fiber materials may include polyesters, polyolefins, polyamides and combinations thereof. As will be appreciated, when such materials are extruded from a melt solution into drawn filaments, those filaments have an intrinsic finite shrinkage potential which is activated upon subsequent heat exposure. During heat exposure shrinkage will proceed until the shrinkage potential is exhausted or the heating is terminated.

As shown, the drawing apparatus 132 has a first draw zone 136 located between tensioning rolls 138, 140 and a second draw zone 142 located between tensioning rolls 140 and 146. A contact heating plate 150 as will be well known to those of skill in the art engages the yarns 122 within the second draw zone 142. According to the potentially preferred practice, the partially oriented yarns 122 are passed through the first draw zone 136 at relatively light tension to provide slight drawing elongation. Since the resultant yarn is not drawn to a condition of full orientation it is referred to as “underdrawn” yarn. At the second draw zone 142, the yarns 122 preferably undergo substantially tension free heating. As the yarn cools, the partially oriented condition is retained such that these characteristics are present in the yam at the take-up position 133.

According to a potentially preferred practice using the system of FIG. 3, the yarn is conveyed across the contact heater 150 at a rate of speed such that the yarn reaches a state of temperature equilibrium within the cross-section of the yarn at all segments along its length. By way of example only, and not limitation, for a polyester yarn it has been found that subjecting such yarn to a draw ratio of about 1.14 with a 19 inch long contact heater temperature of about 150 degrees Celsius to about 200 degrees Celsius with a take up speed of about 450-600 yards per minute (409-546 meters per minute) provides the desired uniform cross-sectional heat treatment. The resultant yarn has substantial retained plastic strain capacity. At such treatment conditions, polyester yarn is characterized by plastic elongation in the fabric construction state of about 80-85 percent. Of course, the level of drawing, temperature and speed may be adjusted to yield different elongation characteristics. In particular, it is contemplated that draw ratios up to about 1.50 may be utilized across the heater 150. Likewise, a change in the yarn polymer will permit adjustment to elongation. For example, polypropylene yarns may exhibit elongation of several hundred percent.

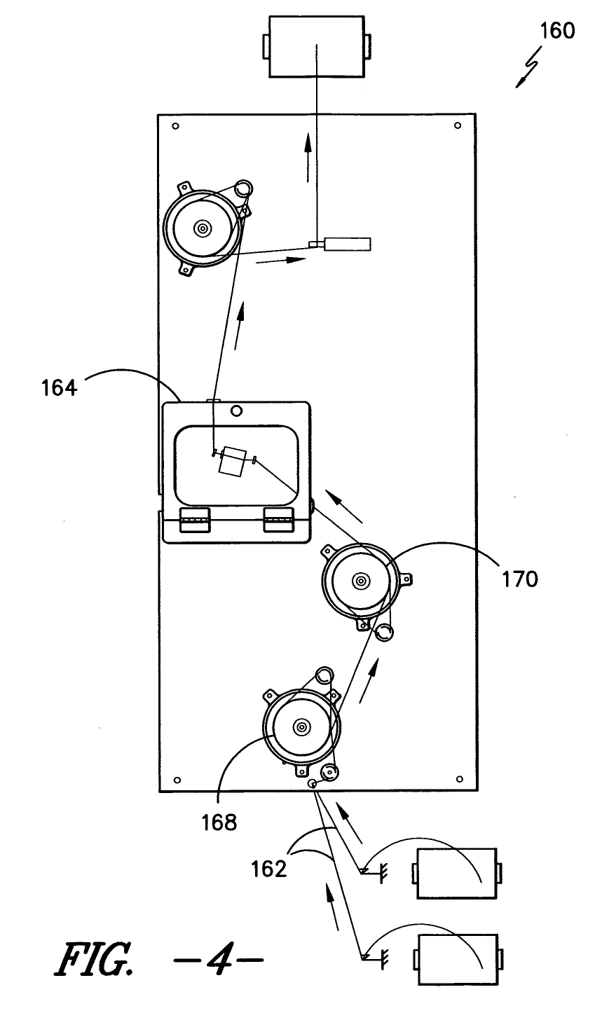

Another exemplary process for treatment of yarn to yield the desired levels of residual plastic strain is illustrated in FIG. 4. In this procedure, an air jet texturing machine 160 such as is available from Stahle Eltex is used to heatset the partially oriented yarn as the yarn is conveyed to an air jet texturing station 164. In particular, according to this practice the POY is delivered around a first godet roll 168 substantially without heat application and then to a second godet roll 170 at a temperature of about 120 degrees Celsius to about 150 degrees Celsius. The POY is preferably processed at speeds of about 350 to about 800 meters per minute (about 385 to about 879 yards per minute) with a draw ratio of about 1.0 (i.e. no draw). At the texturing station 164, the POY is preferably plied together using an air jet with about 5% to about 15% overfeed. The resultant polyester yam has substantial retained plastic strain capacity such that the yam is characterized by plastic elongation to failure in the fabric construction state of about 90% to about 100%.

It has also been found that the yarn may be substantially fully cold drawn and then heat shrunk with substantial overfeed so as to yield a shrunken yam with an overall draw ratio of less than 1.0 thereby creating a highly extensible product. Such a process can be carried out using the systems as illustrated and described in relation to FIGS. 3 and 4. Such yams may have dramatic plastic deformation potential up to about 140% for polyester.

Regardless of the treatment process used, the underdrawn POY yams are characterized by substantial non-recoverable plastic phase elongation at relatively low tensions. Such characteristics are typically considered undesirable in fabric constructions due to the lack of stability. However, in the present practice these deformable yams are nonetheless formed into woven or knitted fabrics for use in the surface of the composite 110 as previously described. By way of example only, such yams may be formed into plain or fancy (jacquard) weaves as well as circular knits, warp knits and knitted double needle bar spacer fabrics. As illustrated in FIG. 2, the fabric may be dyed such as by jet dyeing or the like to provide a desired color characteristic. Of course, it is also contemplated that the yams forming the fabric may be of so called “solution dyed” character if desired so as to eliminate the need for post-formation dyeing.

Regardless of whether or not a dyeing step has been used, it has been found that the resultant fabrics are characterized by a substantial tension-induced elongation or stretch capacity after the fabric has been formed. Importantly, this stretch capacity is such that there is only minimal recovery following release of the tensioning force. As reflected by stress-strain curves developed using the modified ball burst test, the initial stress to draw the fabrics is controlled primarily by the fabric construction. After the construction strain potential is exhausted, the remaining strain comes from the residual elongation of the yam until it breaks. That is, after the fabric is stretched to any substantial level, it substantially holds its stretched position even without applied tension. Moreover, in many constructions the fabric is characterized by a relatively low modulus in both the machine and the cross machine direction. This permits the fabric to be molded to desired configurations at low forces characteristic of ram assisted vacuum molding operations without unduly stressing the material.

As previously indicated, in actual molding practice, it is contemplated that following formation and any dyeing process, the fabric will be laminated to an extensible low permeability composite backing such that the fabric defines an outer show surface. As will be appreciated, in such a construction the surface fabric is required to undergo substantial stretching without imparting significant recovery forces to the composite since any applied recovery forces will be magnified due to the distance away from the centerline of the composite.

It is hypothesized that by utilizing yams processed to have substantial residual deformation, extension of the resultant fabric is substantially plastic in character such that elastic recovery forces are minimal. Accordingly, the fabric stretches in a plastic mode substantially coextensive with the substrate material and thereafter exhibits only minimal recovery forces such that the stretched condition is maintained.

As noted previously, it has been found that moldable composites incorporating surface fabrics formed from yams of substantially non-recoverable extensible character may find particular application in thermal molding across relatively deep concave surfaces. The benefits of using such fabrics may be particularly acute in environments that must withstand rigorous use and/or substantial temperature variations over the useful life without being susceptible to delamination. It is contemplated that one particular environment where such composites may be useful is at interior portions of an automobile. In particular, it is contemplated that such composites may be used in overlying adhered relation to highly contoured solid surfaces such as depressions within door panels and/or across segments of instrument panels that may have depressions for instruments, change trays, cup holders and the like. Of course, such uses are exemplary only and the composites may be used in virtually any other environment as may be desired.

Various features of the invention may be further understood through reference to the following non-limiting examples.

### EXAMPLES 1-10

Various fabrics and fabrics with foam backings were subjected to deep draw simulations using the procedures of ASTM Standard D 6797-02 modified to use a slightly larger ball diameter and sample holder. In particular, the samples tested were held on a 6 inch ring holder and a 4.25 inch diameter ball shaped ram element was extended through the center of the sample until the sample began to fail. Using a load cell mounted on the ram element, the stress-strain curve was developed. Peak load and the extension at peak load were recorded along with the modulus at peak load and at 50% of peak load.

### EXAMPLE 1

### Woven

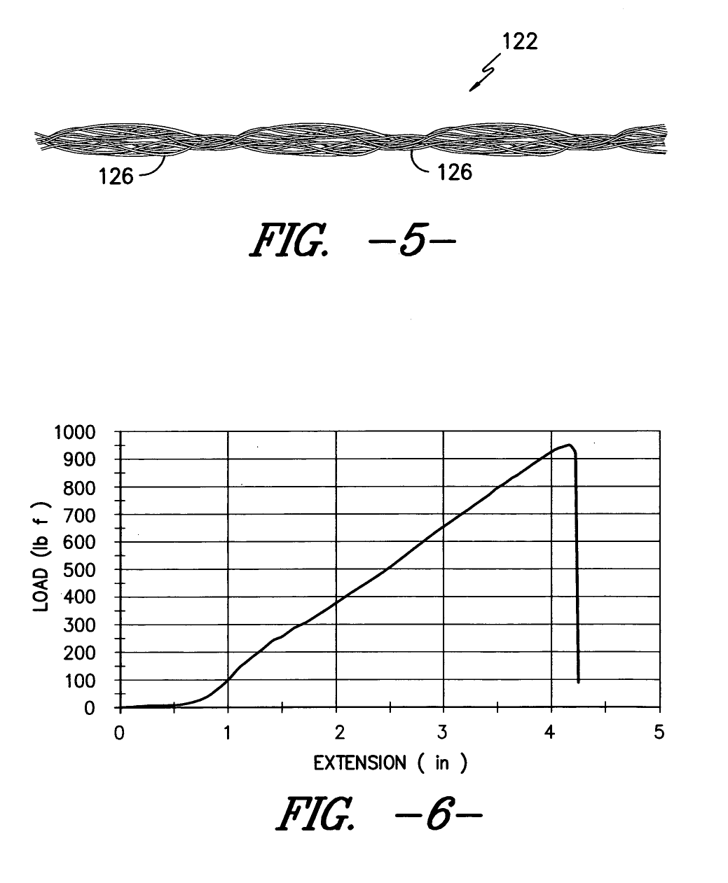

A jacquard flat woven fabric with characteristics found to be suitable for composite molding as outlined above was formed on a Dornier Rapier Jacquard loom from 100% polyester yarn. The warp yarn and the filling yarn were both 2 ply 260 denier 68 filament count solution dyed POY subjected to a heat setting process at 140 degrees Celsius over a godet roll with substantially no draw as described in relation to FIG. 4. The finished fabric had 52 picks per inch× 73.5 ends per inch. When tested in the manner described above, the fabric was characterized by a peak load of 947 pounds force, a stress at peak compression of 134 PSI, an extension at break of 4.2 inches (as measured by ram extension), a modulus at peak load of 46.5 PSI and a modulus at 50% peak load of 64.6 PSI. The resulting stress-strain curve is shown in FIG. 6

### EXAMPLE 2

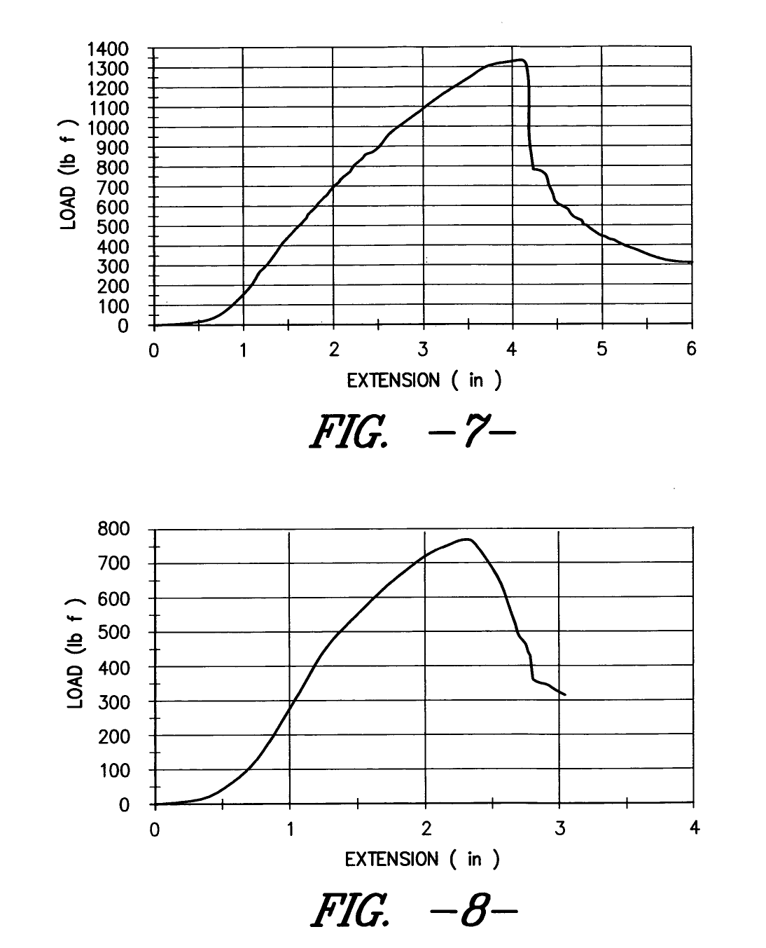

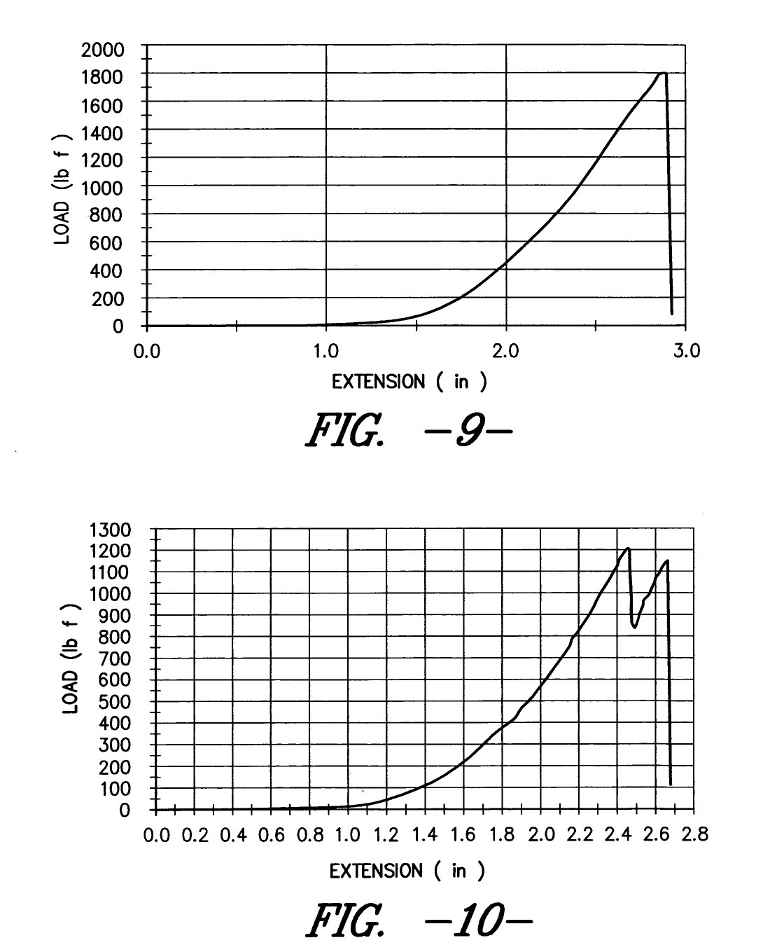

The fabric of Example 1 was adhered to a closed cell polypropylene foam layer as previously described using an ethylene methyl acrylate (EMA) adhesive. The foam layer was 4 mm thick. The fabric with foam backing was then tested in the manner as described above. The fabric with 4 mm foam was characterized by a peak load of 1336 pounds force, a stress at peak compression of 189 PSI, an extension at break of 4.1 inches (as measured by ram extension), a modulus at peak load of 68.3 PSI and a modulus at 50% peak load of 120.8 PSI. The resulting stress-strain curve is shown in FIG. 7.

### EXAMPLE 3

The fabric of Example 1 was adhered to a closed cell polypropylene foam layer as described above using an ethylene methyl acrylate (EMA) adhesive. The foam layer was 1.5 mm thick with a 10 mil thickness layer of polypropylene film on the fack of the foam. The fabric with foam backing was then tested in the manner as described above. The fabric with 1.5 mm foam was characterized by a peak load of 771.4 pounds force, a stress at peak compression of 109.2 PSI, an extension at break of 2.307 inches (as measured by ram extension), a modulus at peak load of 104.4 PSI and a modulus at 50% peak load of 190.1 PSI. The resulting stress-strain curve is shown in FIG. 8.

### EXAMPLE 4

### Comparative

A flat woven 2×2 basket weave fabric believed to be unsuitable for composite molding was formed on a Nissan Waterjet loom from 100% polyester yarn. The warp yam and the filling yam were both substantially fully drawn 3 ply 150 denier 34 filament count yams. The finished fabric had 44 picks per inch×64 ends per inch. When tested in the manner described above, the fabric was characterized by a peak load of 1814 pounds force, a stress at peak compression of 256.9 PSI, an extension at break of 2.9 inches (as measured by ram extension), a modulus at peak load of 165.1 PSI and a modulus at 50% peak load of 14.8 PSI. The resulting stress-strain curve is shown in FIG. 109.

### EXAMPLE 5

### Comparative

A jacquard flat woven fabric believed to be unsuitable for composite molding was formed on a Nissan waterjet loom Dornier Rapier Jacquard loom from 100% polyester yam. The warp yam and the filling yam were both substantially fully drawn false twist textured 2 ply 150 denier 34 filament count yams. The finished fabric had 50 picks per inch×70 ends per inch. When tested in the manner described above, the fabric was characterized by a peak load of 1215.9 pounds force, a stress at peak compression of 172.1 PSI, an extension at break of 2.5 inches (as measured by ram extension), a modulus at peak load of 146.4 PSI and a modulus at 50% peak load of 24.2 PSI. The resulting stress-strain curve is shown in FIG. 10.

### EXAMPLE 6

### Comparative

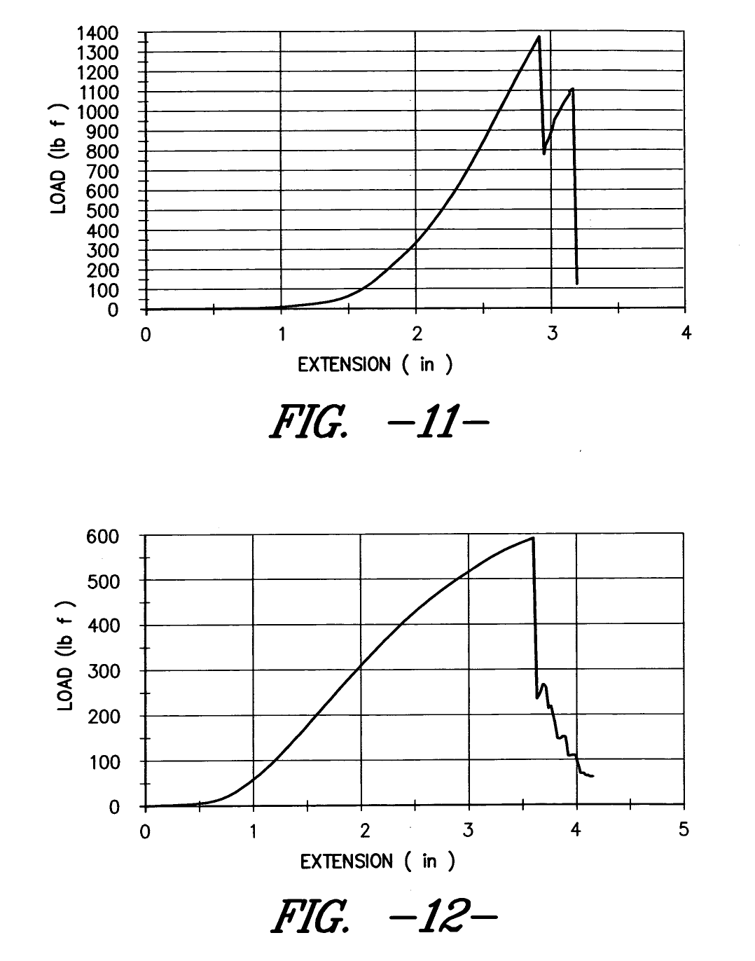

A jacquard flat woven fabric believed to be unsuitable for composite molding was formed on a Nissan waterjet loom Dornier Rapier Jacquard loom from 100% polyester yarn. The warp yarn was a substantially fully drawn false twist textured 2 ply 150 denier 34 filament count yarn. The filling yarn was a substantially fully drawn airjet textured 2 ply 150 denier 34 filament count yarn. The finished fabric had 51 picks per inch×77 ends per inch. When tested in the manner described above, the fabric was characterized by a peak load of 1389.6 pounds force, a stress at peak compression of 196.7 PSI, an extension at break of 2.9 inches (as measured by ram extension), a modulus at peak load of 123.2 PSI and a modulus at 50% peak load of 18.2 PSI. The resulting stress-strain curve is shown in FIG. 11.

### EXAMPLE 7

### Warp Knit

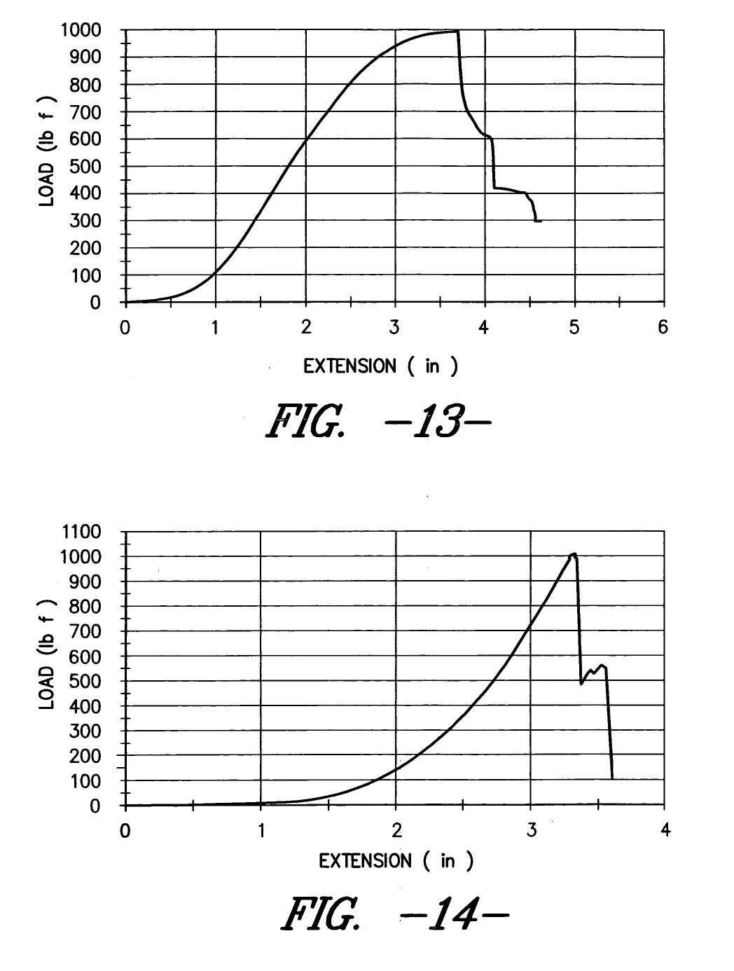

A three bar single needle bar flat warpknit with characteristics suitable for composite molding as outlined above was formed on a warp knitting machine from 100% polyester yarn. The yarns were all 170 (150)/36 semidull round POY subjected to a drawing and heat setting process substantially as described in relation to FIG. 3 with a draw ratio of about 1.14. Bar 1 was threaded at 1 in, 1 out with a pattern of 10/01/11/11. Bar 2 was threaded at 1 in, 1 out with a pattern of 11/11/10/01. Bar 3 was fully threaded with a pattern of 10/34. The finished fabric had 56 courses per inch×29 wales per inch. When tested in the manner described above, the fabric was characterized by a peak load of 590.8 pounds force, a stress at peak compression of 83.6 PSI, an extension at break of 3.6 inches (as measured by ram extension), a modulus at peak load of 37 PSI and a modulus at 50% peak load of 54.9 PSI. The resulting stress-strain curve is shown in FIG. 12.

### EXAMPLE 8

The fabric of Example 7 was adhered to a closed cell polypropylene foam layer as previously described using an ethylene methyl acrylate (EMA) adhesive. The foam layer was 4 mm thick with a 1.5 mm thick layer of polypropylene film on the back of the foam.

The fabric with foam backing was then tested in the manner as described above. The fabric with 4 mm foam was characterized by a peak load of 997 pounds force, a stress at peak compression of 141.1 PSI, an extension at break of 3.6 inches (as measured by ram extension), a modulus at peak load of 62.5 PSI and a modulus at 50% peak load of 105 PSI. The resulting stress-strain curve is shown in FIG. 13.

### EXAMPLE 9

### Comparative

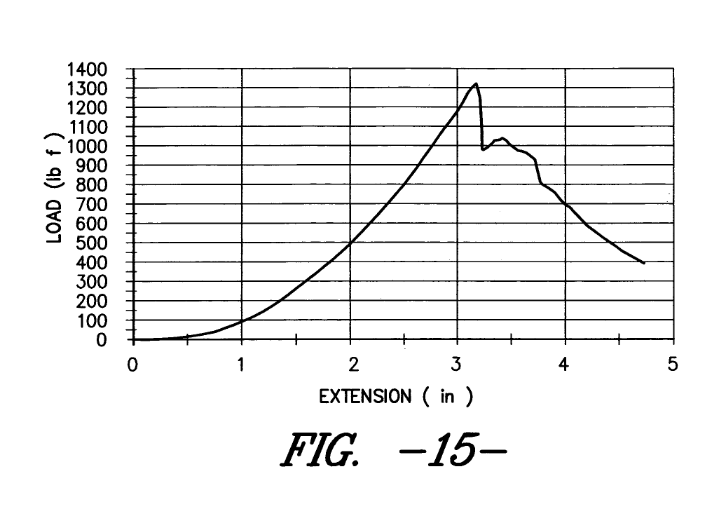

A commercially available three bar single needle bar flat warpknit believed to be unsuitable for composite molding formed on a warp knitting machine from 100% polyester yam was tested for comparison to Example 7. The yams were all single ply 150/36 semidull round fully drawn false twist textured yams. Bar 1 was threaded at 1 in, 1 out with a pattern of 10/01/11/11. Bar 2 was threaded at 1 in, 1 out with a pattern of 11/11/10/01. Bar 3 was fully threaded with a pattern of 10/34. The finished fabric had 49 courses per inch×29 wales per inch. When tested in the manner described above, the fabric was characterized by a peak load of 1010.2 pounds force, a stress at peak compression of 143 PSI, an extension at break of 3.3 inches (as measured by ram extension), a modulus at peak load of 71.8 PSI and a modulus at 50% peak load of 16.1 PSI. The resulting stress-strain curve is shown in FIG. 14.

### EXAMPLE 10

### Comparative

The fabric of Example 9 was adhered to a closed cell polypropylene foam layer as previously described using an ethylene methyl acrylate (EMA) adhesive. The foam layer was 4 mm thick with a 1.5 mm thick layer of polypropylene film on the back of the foam. The fabric with foam backing was then tested in the manner as described above for comparison to Example 8. The fabric with 4 mm foam was characterized by a peak load of 1315.9 pounds force, a stress at peak compression of 186.2 PSI, an extension at break of 3.2 inches (as measured by ram extension), a modulus at peak load of 101.4 PSI and a modulus at 50% peak load of 80.6 PSI. The resulting stress-strain curve is shown in FIG. 15.

It is to be understood that the detailed description as well as the specific examples presented herein are intended to be illustrative and explanatory only. Thus, while the invention has been described in relation to potentially preferred embodiments, constructions, and procedures, the invention is in no event to be limited thereto. Rather, it is contemplated that modifications and variations embodying the principles of the invention will no doubt occur to those of ordinary skill in the art. It is therefore contemplated and intended that the present invention shall extend to all such modifications and variations as may incorporate the broad aspects of the invention within the true spirit and scope thereof.

What is claimed is:

1. A method of forming a moldable fabric face composite adapted for molding to a three dimensional shape, the method comprising the steps of:
(a) forming a plurality of partially oriented yams from plastically deformable polymeric material;
(b) heat setting said plurality of yams such that said yams are characterized by a retained plastic elongation potential of about 40% or greater;
(c) forming said plurality of partially oriented yams into a knit or woven fabric structure; and
(d) adhering said fabric structure to a plastically deformable backing to form a laminate composite, wherein said laminate composite is adapted for plastic deformation in substantially conforming relation to concave surfaces of an underlying structure.

2. The method as recited in claim 1, wherein said polymeric material is a polyester.

3. The method as recited in claim 1, wherein said fabric structure is a warp or circular knit.

4. The method as recited in claim 3, wherein during the forming step said partially oriented yams are knit in combination with fully oriented yams.

5. The method as recited in claim 1, wherein during the heat setting step the plurality of yams are drawn across a heated surface.

6. The method as recited in claim 1, comprising the further step of dyeing the fabric structure at an elevated temperature of not less than about 100 degrees Celsius prior to the adhering step.

7. The method as recited in claim 1, wherein the backing comprises a foam layer disposed in adjoined relation to a thermoplastic backing layer.

8. The method as recited in claim 7, wherein the foam layer consists essentially of a closed cell polypropylene foam having a thickness in the range of about 1 to 8 millimeters.

9. The method as recited in claim 8, wherein the backing layer consists essentially of polypropylene.

10. The method as recited in claim 9, wherein the backing layer consists essentially of extrusion coated polypropylene.

11. The method as recited in claim 9, wherein the foam layer consists essentially of a closed cell polypropylene foam having a thickness in the range of about 2 to 4 millimeters.

12. A moldable fabric face composite formed by the method of claim 11.

13. A moldable fabric face composite formed by the method of claim 1.

14. A method of forming a moldable fabric face composite adapted for molding to a three dimensional shape, the method comprising the steps of:
(a) forming a plurality of partially oriented yarns from plastically deformable polymeric material;
(b) heat setting said plurality of yarns such that said yams are characterized by a retained plastic elongation potential of greater than about 40%;
(c) forming said plurality of partially oriented yams into a knit or woven fabric structure, wherein said fabric structure is characterized by a stress-strain relationship when subjected to a modified ball burst test pursuant to ASTM standard D 6797-02 such that the modulus measured at 50 percent of a peak load level is at least 20% greater than the modulus at said peak load level; and
(d) adhering said fabric structure to a plastically deformable multilayer backing to form a laminate composite, wherein said laminate composite is adapted for plastic deformation in substantially conforming relation to concave surfaces of an underlying structure.

15. The method as recited in claim 14, wherein said polymeric material is a polyester.

16. The method of claim 15, wherein said fabric structure is a woven fabric.

17. The method as recited in claim 15, wherein said fabric structure is a warp or circular knit.

18. The method as recited in claim 15, wherein said fabric structure is a knit fabric characterized by a stress-strain relationship when subjected to a modified ball burst test pursuant to ASTM standard D 6797-02 such that the modulus measured at 50 percent of a peak load level is at least 30% percent greater than the modulus at said peak load level.

19. The method as recited in claim 14, wherein during the forming step said partially oriented yams are knit or woven in combination with fully oriented yams.

20. The method as recited in claim 14, wherein during the heat setting step, the plurality of yams are drawn across a heated surface.

21. The method as recited in claim 14, comprising the further step of dyeing the fabric structure at an elevated temperature of not less than about 100 degrees Celsius prior to the adhering step.

22. The method as recited in claim 14, wherein the multi-layer backing comprises a foam layer disposed in adjoined relation to a thermoplastic non-cellular backing layer.

23. The method as recited in claim 22, wherein the foam layer consists essentially of a closed cell polypropylene foam having a thickness in the range of about 1 to about 8 millimeters.

24. The method as recited in claim 23, wherein the backing layer consists essentially of polypropylene.

25. The method as recited in claim 24, wherein the foam layer has a thickness in the range of about 2 to about 4 millimeters.

26. A moldable fabric face composite formed by the method of claim 25.

27. A moldable fabric face composite formed by the method of claim 14.

28. A method of forming a moldable fabric face composite adapted for molding to a three dimensional shape, the method comprising the steps of:
(a) forming a plurality of partially oriented polyester yams;
(b) heat setting said plurality of yams such that said yams are characterized by a retained plastic elongation potential of about 60% to about 140%;
(c) forming said plurality of partially oriented yams into a knit or woven fabric structure; and
(d) adhering said fabric structure to a backing structure comprising a closed cell polypropylene foam having a thickness of about 1 to 8 millimeters and a substantially non-cellular polypropylene backing layer to form a laminate composite, wherein said laminate composite is characterized by a stress-strain relationship when subjected to a modified ball burst test pursuant to ASTM standard D 6797-02 such that the modulus measured at 50 percent of a peak load level is at least 20% greater than the modulus at said peak load level.

29. The method as recited in claim 28, wherein the foam has a thickness of about 2 to about 4 millimeters.
